(19) United States
(12) Patent Application Publication
(10) Pub. No.: US 2013/0130203 A1
(43) Pub. Date: May 23, 2013

(54) POLYMER COATED DENTAL ARTICLES AND METHOD OF MAKING THE SAME

(71) Applicants: Bhaskar V. Velamakanni, Woodbury, MN (US); Todd D. Jones, St. Paul, MN (US); Sumita B. Mitra, West St. Paul, MN (US); Anupa N. Patel, Minneapolis, MN (US)

(72) Inventors: Bhaskar V. Velamakanni, Woodbury, MN (US); Todd D. Jones, St. Paul, MN (US); Sumita B. Mitra, West St. Paul, MN (US); Anupa N. Patel, Minneapolis, MN (US)

(73) Assignee: 3M INNOVATIVE PROPERTIES COMPANY, ST. PAUL, MN (US)

(21) Appl. No.: 13/813,682

(22) PCT Filed: Aug. 8, 2011
(86) PCT No.: PCT/US2011/046909

§ 371 Date: Feb. 1, 2013

Related U.S. Application Data
(60) Provisional application No. 61/372,732, filed on Aug. 11, 2010.

(51) Int. Cl. A61C 5/10

(52) U.S. Cl. CPC A61C 5/10
USPC 433/222.1; 427/2.29; 118/200

(57) ABSTRACT

Provided are methods of improving the wear resistance and aesthetic properties of dental articles, as well as dental articles having an abrasion resistant polymeric coating thereon.

### BACKGROUND

Flexible metal articles are desirable for treatment of a variety of dental maladies. Such articles have proven reasonably durable over both short-term and long-term dental treatment. Dental articles made from or including a malleable metal substrate may typically be modified chair side to adapt to the tooth structures of a particular patient and can ensure a secure installation. This degree of post-manufacturing freedom has made malleable metal especially popular as dental crowns and orthodontic bands.

Metal crowns, particularly those made of stainless steel, are well suited for children, as their reasonable life span coincides with the natural loss of children's teeth. The metallic sheen of stainless steel, however, is not exactly aesthetically appealing. Accordingly, attempts have been made to apply aesthetic coatings to stainless steel crowns, but these efforts have experienced little success in maintaining flexibility and durability.

### SUMMARY

Stainless steel and most other untreated or uncoated metals have become increasingly unappealing to patients desiring high-quality aesthetics in addition to high performance and durability. Accordingly, there is an increased demand for dental articles that match or mimic the natural color of teeth. Attempts to meet this demand, including coating with certain polymer resins, have been thus far been less than desirable. In some prior art solutions, the coating does not sufficiently adhere to the surface during the entirety of treatment or the coating becomes easily stained upon exposure to food. In other prior art solutions, the required coating is so thick that the crown may not be freely manipulated without cracking, potentially requiring substantial removal of the tooth structure for seating the crown. Such substantial removal may lead to increased patient sensitivity and other complications.

The dental articles of the present disclosure include a polymer coating having two or more polymeric layers on at least a portion of the article's outer surface. The polymer coating of the present disclosure exhibits improved wear and stain resistance while maintaining aesthetic appeal during the full period of treatment. The polymer coating of the present disclosure further provides a smooth outer surface for the dental article, reducing patient discomfort upon tongue or lip contact.

Unlike previous aesthetic dental articles, the polymer coated dental articles maintain desired flexibility such that they may be cut, bent, crimped, or otherwise manipulated by a practitioner without delamination or other failure. Therefore, use of the coated dental articles may allow a dental practitioner to precisely modify the fit or shape of the dental article without sacrificing performance or appearance.

The polymer coated dental articles of the present disclosure may be crimped and/or otherwise manipulated without deleteriously affecting the aesthetics or performance of the coating. The coating is sufficiently thin on at least portions of the outer surface so as to be pliable enough to undergo manipulation without damage or failure. The coating is also sufficiently thick in order to withstand typical mastication (i.e., chewing) and oral preventive care (e.g., brushing) forces throughout the life of the article.

The present disclosure provides methods of coating a dental article. In one aspect, the method includes: providing a dental crown comprising a metal substrate and depositing a coating. Depositing the coating includes depositing a first hardenable composition on at least a portion of the outer surface of the crown, wherein said depositing forms a first polymer layer and depositing a second hardenable composition on at least a portion of the first polymer layer, wherein depositing the second hardenable composition forms a second polymer layer. Each of the first and second hardenable compositions includes a polymerizable component and one of the first and second hardenable compositions is deposited substantially above the height of contour.

In another aspect, the methods further comprise depositing a third hardenable composition to form a third polymer layer, and wherein the third hardenable composition comprises a polymerizable component.

The present disclosure also provides for coated dental articles. In one aspect, a dental article includes a dental crown having a height of contour and a first layer of material disposed on at least a portion of the outer surface of the crown, the first layer including a first hardened dental composition. A second layer of material is disposed on at least a portion of the first layer, the second layer including a second hardened dental composition. Either the first or second layer is disposed on the crown substantially above the height of contour.

In another aspect, the coated dental article includes a third polymer layer including a third hardenable composition.

As used herein, the term “hardenable” refers to a material that can be cured or solidified, e.g., by heating to remove solvent, heating to cause polymerization, chemical crosslinking, radiation-induced polymerization or crosslinking, or the like.

As used herein, “curing” means the hardening or partial hardening of a composition by any mechanism, e.g., by heat, light, radiation, e-beam, microwave, chemical reaction, or combinations thereof.

As used herein, the term “hardenable composition” refers to a hardenable composition of the present disclosure at a point in time before curing.

As used herein, “dental article” means an article that can be adhered (e.g., bonded) to an oral surface (e.g., a tooth structure). Examples include, but are not limited to, replacements, inlays, onlays, veneers, full and partial crowns (temporary and permanent), bridges, implants, implant abutments, copings, dentures, posts, bridge frameworks and other bridge structures, abutments, orthodontic appliances and devices (e.g., archwires, buccal tubes, brackets, and bands), and prostheses (e.g., partial or full dentures).

As used herein, the term “ethylenically unsaturated compound” is meant to include monomers, oligomers, and polymers having at least one ethylenic unsaturation.

As used herein, the term “nanofiller” means a filler having an average primary particle size of at most 200 nanometers. The nanofiller component may be a single nanofiller or a combination of nanofillers.

As used herein, the term “(meth)acrylate” is a shorthand reference to acrylate, methacrylate, or combinations thereof, and “(meth)acrylic” is a shorthand reference to acrylic, methacrylic, or combinations thereof. As used herein, “(meth)acrylate-functional compounds” are compounds that include, among other things, a (meth)acrylate moiety.

As used herein, “phosphorylated monomer” refers to a monomer (e.g., a (meth)acrylate) that comprises at least one phosphate or phosphonate group.

As used herein, the term “thermal initiator” means a species capable of efficiently inducing or causing polymerization or crosslinking by exposure to heat.

As used herein, “continuous” means extending substantially across a target surface and including no deliberate gaps or interruptions other those inherent in the material.

As used herein, “occlusal” means in a direction toward the outer tips of the patient's teeth.

As used herein, “gingival” means in a direction toward the patient's gums or gingiva.

As used herein, “proximal surface” means the surface nearest to the adjacent tooth.

As used herein, “interproximal” means between the proximal surfaces of adjoining teeth.

As used herein, “anterior crown” means a crown intended to replace incisor and canine teeth.

As used herein, “height of contour” means the point of greatest convexity of a tooth or crown.

As used in the claims, “filler” means nanofiller, other filler, and combinations thereof.

As used herein, deposited or disposed “substantially above the height of contour” and variations means little to no coating is deliberately deposited the below the height of contour.

As used herein, “a,” “an,” “the,” “at least one,” and “one or more” are used interchangeably. Thus, for example, a hardenable composition that comprises “a” polymerizable component can be interpreted to mean that the hardenable composition includes “one or more” polymerizable components. Similarly, a hardenable composition comprising “a” filler can be interpreted to mean that the composition includes “one or more” fillers.

As recited herein, all numbers should be considered modified by the term “about”.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The invention will be further described with reference to the drawings, wherein corresponding reference characters indicate corresponding parts throughout the several views, and wherein:

FIG. 1 is a perspective view of a stainless steel crown.

FIG. 2 is a front plan view of a coated stainless steel crown according to an embodiment of the present disclosure.

FIG. 3 is a cross-sectional view of the stainless steel crown of FIG. 2.

FIG. 4 is an enlarged cross-sectional view of a stainless steel crown according to an embodiment of the present disclosure.

Layers in the depicted embodiments are for illustrative purposes only and are not intended to define the thickness, relative or otherwise, or the location of any component.

### DETAILED DESCRIPTION OF ILLUSTRATIVE EMBODIMENTS

The dental articles of the present disclosure include a multilayer polymer coating on at least a portion of the article's outer surface. The multilayer polymer coatings of the present disclosure exhibit improved wear and stain resistance while maintaining aesthetic appeal during the full period of treatment. Unlike previous aesthetic dental articles, the coated dental articles of the present disclosure can maintain desired flexibility such that they may be cut, bent, crimped, or otherwise manipulated by a practitioner without delamination or other failure. Therefore, use of the coated dental articles allows a dental or orthodontic practitioner to precisely modify the fit or shape of the dental article without sacrificing performance or appearance.

Polymer coated dental articles of certain embodiments of the present disclosure may be crimped and/or otherwise manipulated without deleteriously affecting the aesthetics or performance of the coating. The multiple polymeric layers can further cooperate to closely approximate the patient's tooth color, or such color may be imparted by a single polymeric layer.

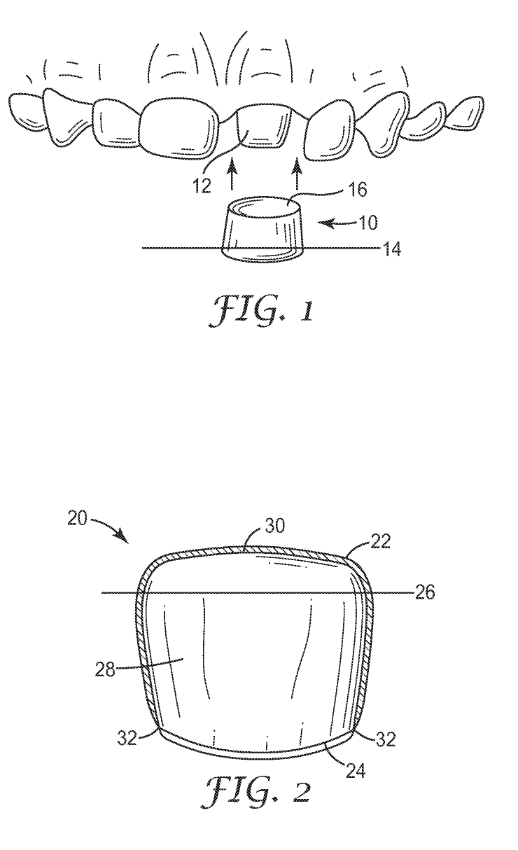

A coated dental article according to one embodiment of the present disclosure is a stainless steel crown (SSC). A typical SSC is constructed from a preformed base material crown 10 composed of stainless steel, which is placed in the mouth to cover a prepared tooth 12 as shown in FIG. 1. The prepared tooth 12 is shown as having its surface ground away sufficient for the placement of the crown 10 thereon. The scale of the teeth shown and the crown 10 to be placed thereon is for ease of illustration and should not be considered to be at the correct scale. Furthermore, the portion of the tooth 12, which has been ground away, is also for illustration purposes only. As shown in FIG. 1, the base metal crown 10, which as shown for illustration purposes, is not a molar, and therefore can be pictured generally as a flattened bowl which is formed in the shape of a tooth with an open end 16 for placement over the prepared tooth 12. Proper tooth preparation includes removing all caries and proper shaping of the remaining natural tooth 12 to receive the SSC 10. Therefore, the prepared tooth 12 is typically left in place in the mouth so that its root provides anchor in the jaw for the SSC 10. The SSC 10 shown in FIG. 1 is an anterior crown; however, it is to be understood that the present disclosure is applicable to both anterior and to posterior crowns as well.

Typically an SSC is shaped to resemble the tooth that it replaces and is sized to fit comfortably over the portion of the tooth on which the dental procedure is being performed. The crown is trimmed so that the bottom edge of the crown meets the gum line in a comfortable manner approximating the placement of the tooth when the crown is applied. The crowns are manufactured in sizes and shapes to fit the various types of teeth. The stainless steel is preferably malleable so it can be crimped around the base of the tooth and shaped on the occlusal surface to provide a comfortable bite with the opposing tooth. Precise adjustments by a practitioner to the shape and/or size the SSC are often, though not always, made to the portion of the SSC below the height of contour 14.

Commercially available preformed stainless steel crowns can be obtained from 3M Company, St. Paul, Minn. Other sources of preformed stainless steel crowns include Acero XT, Dallas, Tex. and Denovo Dental, Baldwin Park, Calif.

The preformed base metal in a SSC is typically constructed of cold rolled stainless steel. Prior to coating, the crown can be prepared to remove oil or other surface contaminants by vapor degreasing, alkaline cleaning, acetone cleaning, or ultra-sonic cleaning, for example, as needed. Surface oxides may be removed and surface activation can be accomplished by acid treatment or abrasive blasting, for example, as described in more detail below.

Typical stainless steel materials used to construct stainless steel crowns useful in the present disclosure include AISI-Types 304, 305, and 316 stainless steel sheeting (based on the American Iron and Steel Institute Classification of Chromium-Nickel Stainless Steels). Such sheeting includes a metal alloy of iron, chromium, and nickel typically with small or trace amounts of manganese, carbon, titanium, aluminum, silicon, tantalum, and molybdenum.

FIG. 2 depicts a front plan view of an aesthetic posterior SSC 20 including a multilayer polymer coating 22. The exterior of the crown includes a height of contour 26 extending across the wall surface 28 below occlusal surface 30 as it transitions into an integral circumferential area or continuous wall. In the depicted embodiment, the entire outer surface of the SSC may be coated with the multilayer polymer coating, including the cervical margins. It is further contemplated that portions of the cervical margin, including those proximate the gingival-labial and the gingival-lingual edge regions 32 may be left uncoated.

Though not depicted, it is also contemplated that the coating be used on anterior crowns. In some embodiments, the entire outer surface of the anterior crown may be coated. In other embodiments, only the portion of the anterior crown that will contact the opposing dentition (e.g., the incisal surface) or the portion above the height of contour need be coated.

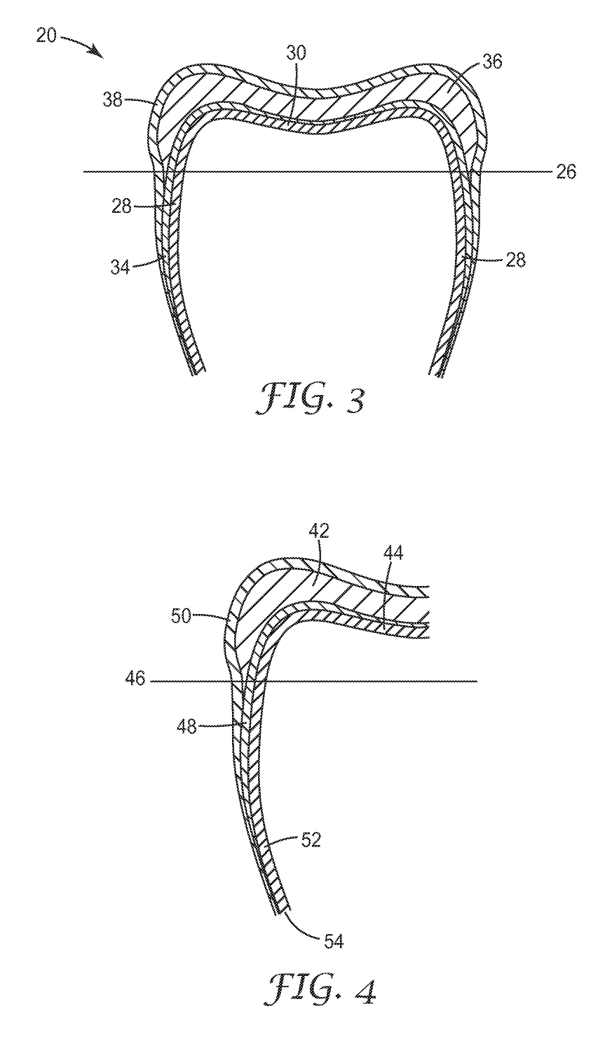

FIG. 3 illustrates a cross-sectional view of the coated SSC 20 of FIG. 2. The outer surface may be primed to include micro texture (e.g., abraded, deposited, or etched) according to methods described herein. A first polymeric layer, basecoat 34, is disposed on the outer surface. As depicted in FIG. 3, the basecoat 34 is continuous over the entire surface of the SSC. A second polymeric layer, hardcoat 36, is disposed on top of the basecoat 34. As depicted, hardcoat 36 is continuous over the occlusal surface 30 of the crown, with limited to no coverage below the height of contour 26. In some embodiments, the hardcoat 36 is disposed on the entire outer surface of the crown or some portion greater than the occlusal surface and less than the entire crown. An optional third polymeric layer, clearcoat 38 is disposed on top of the hardcoat 36 on the occlusal surface 30 and the basecoat 34 on the wall surfaces 28 of the SSC.

It should be appreciated that the basecoat and hardcoat are interchangeable in that the hardcoat may be the first polymeric layer disposed on the outer surface and the basecoat the second polymeric layer disposed on hardcoat. In certain embodiments, the hardcoat is disposed substantially above the height of contour when applied first.

One or more additional polymeric layers are also contemplated, so that a coated dental article may include a plurality of polymeric layers in addition to the multilayer polymeric coating. The additional polymeric layers may be disposed beneath, above, or in between the basecoat, hardcoat, and/or clearcoat.

In some embodiments, the thickness of the coating layer is substantially consistent over the entire coated surface of the dental article. In other embodiments, the coating may include a thickness gradient. Such a gradient may include a gradual decrease or an abrupt decrease in coating thickness, or a combination thereof. For example, the thickness of the coating on the occlusal surface 30 may be greater than the thickness of the coating on the wall surfaces 28 (e.g., the interproximal surfaces) proximate the height of contour 26. Further, the coating thickness may approach zero as the cervical margin is approached. It is also contemplated that the thickness of the coating on the occlusal surface 30 be less than the thickness of the coating on the wall surfaces 28. The coating may include a thickness gradient in the first, second and/or third polymeric layer, or combinations thereof.

In one embodiment, the thickness of the multilayer polymer coating at its thickest point, as measured from the surface of the dental article, is no greater than 500 microns. In a further embodiment, the coating at the thickest point is no greater than 200 microns thick. In a further embodiment, the coating at the thickest point is no greater than 150 microns thick.

The basecoat is preferably sufficiently thin so as to mask the underlying stainless steel while also allowing crimping and manipulation without delamination from the crown surface. In one embodiment, the basecoat is at least 10 microns thick. In a further embodiment, the basecoat is at least 20 microns thick. In a further embodiment, the basecoat is at least 40 microns thick. In a stainless steel crown including a thickness gradient as depicted in FIG. 4 and described above, it should be appreciated that the minimum thickness is in reference to the thickness of the basecoat 34 above the height of contour. In one embodiment, the thickness of basecoat 34 is no greater than 100 microns. In a further embodiment, the thickness of the basecoat 34 is no greater than 75 microns. In a further embodiment, the thickness of the basecoat 34 is no greater than 50 microns.

In certain embodiments, the hardcoat 36 is thicker than either the basecoat 34 or the clearcoat 38 so as to provide sufficient abrasion and wear resistance. In one embodiment, the thickness of the hardcoat 36 is at least 100 microns. In another embodiment, the thickness of the hardcoat 36 is at least 200 microns. In a further embodiment, the thickness of the hardcoat 36 is at least 300 microns. In some embodiments, the thickness of the hardcoat 36 is no greater than 750 microns. In another embodiment, the thickness of the hardcoat 36 is no greater than 500 microns. In a further embodiment, the thickness of the hardcoat 36 is no greater than 400 microns.

In one embodiment, the clearcoat is at least 10 microns thick. In a further embodiment, the clearcoat is at least 20 microns thick. In a further embodiment, the clearcoat 38 is at least 40 microns thick. In a stainless steel crown including a thickness gradient as described above, it should be appreciated that the minimum thickness is in reference to the thickness of the clearcoat 38 above the height of contour. In one embodiment, the thickness of clearcoat 38 is no greater than 100 microns. In a further embodiment, the thickness of the clearcoat 38 is no greater than 75 microns. In a further embodiment, the thickness of the clearcoat 38 is no greater than 50 microns.

As noted above, the thickness of the coating may approach zero on portions of the gingival and/or other interproximal surfaces. In certain embodiments, the thickness of the coating on the wall surfaces below the height of contour is no greater than 150 microns, in other embodiments less than 100 microns, in yet other embodiments less than 50 microns. In a further embodiment, the thickness of the coating on the wall surfaces below the height of contour is no greater than 30 microns. Thicknesses exceeding 150 microns may not provide sufficient flexibility in certain embodiments.

FIG. 4 depicts an embodiment of a SSC 40 that includes the hardcoat 42 on only a portion of the outer surface and thickness gradient in at least one polymeric layer. Like the embodiment depicted in FIG. 3, the hardcoat 42 is disposed substantially above the height of contour 46 on the occlusal surface 44, with little to no coverage below the height of contour 46. As depicted, a basecoat 48 and a clearcoat 50 are disposed on substantially the entire outer surface, although cervical margins may remain uncoated in other embodiments. As can be appreciated with reference to FIG. 4, both the basecoat 48 and the clearcoat 50 are thicker proximate the height of contour 46 than the wall sections 52 nearer the cervical margin 54. As can also be appreciated, the thickness of hardcoat 42 decreases proximate the height of contour 46. In additional embodiments not depicted, the basecoat 48 and/or clearcoat 50 may be thinner on the occlusal surface 44 than on a wall section proximate the height of contour 46.

Exemplary hardenable compositions useful for creating the one or more polymeric layers include at least one of a polymerizable component, an initiator system, a pigment, a nanofiller, a filler, and other additives (e.g., solvents). Useful hardenable compositions for the basecoat may include a polymerizable (i.e., hardenable) component, an initiator system, a nanofiller, a filler, and a pigment. Useful hardenable compositions for the hardcoat typically include a polymerizable component, an initiator system, a nanofiller, a filler and a pigment. In some embodiments, the hardcoat includes a tougher polymer (e.g, UDMA) and/or a greater weight percentage of filler than the basecoat. Hardenable compositions suitable for the clearcoat may include a polymerizable component and an intiator system. In certain embodiments, the clearcoat hardenable composition does not include a pigment or a filler (nano or other).

Any of the components used in any of the hardenable compositions may be the same or different within the group of all hardenable compositions used. For example, both the basecoat and clearcoat may include the same polymerizable component, initiator system, and pigment. The potential components of hardenable compositions suitable for use in the coating are described in more detail below.

### Polymerizable Component

The hardenable compositions of the present disclosure are typically hardenable due the presence of a polymerizable component. In some embodiments, the compositions can be hardened (e.g., polymerized by conventional photopolymerization and/or chemical polymerization techniques) after it has been applied to the surface of a dental article.

In certain embodiments, the compositions are photopolymerizable, i.e., the compositions contain a photoinitiator system that upon irradiation with actinic radiation initiates the polymerization (or hardening) of the composition. In other embodiments, the compositions are chemically hardenable, i.e., the compositions contain a chemical initiator (i.e., initiator system) that can polymerize, cure, or otherwise harden the composition without dependence on irradiation with actinic radiation. Such chemically hardenable compositions are sometimes referred to as “self-cure” compositions.

In other embodiments, the compositions are thermally polymerizable, i.e., the compositions contain a thermal initiator system that upon heating or other application of thermal energy initiates the polymerization (or hardening) of the composition.

The polymerizable component typically comprises one or more ethylenically unsaturated compounds, with or without acid functionality. Examples of useful ethylenically unsaturated compounds include acrylic acid esters, methacrylic acid esters, hydroxy-functional acrylic acid esters, hydroxy-functional methacrylic acid esters, and combinations thereof. The polymerizable component may comprise one or more ethylenically unsaturated compounds, with or without acid functionality that is phosphorylated, such as a phosphorylated methacrylate.

The compositions, especially in photopolymerizable implementations, may include compounds having free radically active functional groups that may include monomers, oligomers, and polymers having one or more ethylenically unsaturated group. Suitable compounds contain at least one ethylenically unsaturated bond and are capable of undergoing addition polymerization. Such free radically polymerizable compounds include mono-, di- or poly-(meth)acrylates (i.e., acrylates and methacrylates) such as, methyl (meth)acrylate, ethyl acrylate, isopropyl methacrylate, n-hexyl acrylate, stearyl acrylate, allyl acrylate, glycerol triacrylate, ethyleneglycol diacrylate, diethyleneglycol diacrylate, triethyleneglycol dimethacrylate, 1,3-propanediol di(meth)acrylate, trimethylolpropane triacrylate, 1,2,4-butanetriol trimethacrylate, 1,4-cyclohexanediol diacrylate, pentaerythritol tetra(meth)acrylate, sorbitol hexacrylate, tetrahydrofurfuryl (meth)acrylate, bis[1-(2-acryloxy)]-p-ethoxyphenyldimethylmethane, bis[1-(3-acryloxy-2-hydroxy)]-p-propoxyphenyldimethylmethane, ethoxylated bisphenolA di(meth)acrylate, and trishydroxyethyl-isocyanurate trimethacrylate; (meth)acrylamides (i.e., acrylamides and methacrylamides) such as (meth)acrylamide, methylene bis-(meth)acrylamide, and diacetone (meth)acrylamide; urethane (meth)acrylates; the bis-(meth)acrylates of polyethylene glycols (preferably of molecular weight 200-500), copolymerizable mixtures of acrylated monomers such as those in U.S. Pat. No. 4,652, 274 (Boettcher et al.), acrylated oligomers such as those of U.S. Pat. No. 4,642,126 (Zador et al.), and poly(ethylenically unsaturated) carbamoyl isocyanurates such as those disclosed in U.S. Pat. No. 4,648,843 (Mitra); and vinyl compounds such as styrene, diallyl phthalate, divinyl succinate, divinyl adipate and divinyl phthalate. Other suitable free radically polymerizable compounds include siloxane-functional (meth)acrylates as disclosed, for example, in WO-00/38619 (Guggenberger et al.), WO-01/92271 (Weinmann et al.), WO-01/07444 (Guggenberger et al.), WO-00/42092 (Guggenberger et al.) and fluoropolymer-functional (meth)acrylates as disclosed, for example, in U.S. Pat. No. 5,076,844 (Fock et al.), U.S. Pat. No. 4,356,296 (Griffith et al.), EP-0373 384 (Wagenknecht et al.), EP-0201 031 (Reiners et al.), and EP-0201 778 (Reiners et al.). Mixtures of two or more free radically polymerizable compounds can be used if desired.

The polymerizable component may also comprise monomers that are curable by ring-opening metathesis polymerization (ROMP) having at least one functionality curable by ROMP, such as at least one endocyclic olefinically unsaturated doublebond. Generally, suitable monomers can follow the general formula B-Aₙ wherein A is a moiety polymerizable by ROMP such as cyclobutenyl, cyclopentenyl, cyclooctenyl or bicyclic ring systems like the often preferred norbornenyl and 7-oxa-norbornenyl groups, and B is an organic or silicon-organic backbone with 1 to 100, e.g., 1 to 10 or 1 to 5 or 1 to 4 moieties polymerizable by ROMP, e.g., 2 or 3 moieties polymerizable by ROMP, are attached, n being 1 to 100. The composition according to the disclosure may contain only one type of monomer according to the general formula B-Aₙ. It is also possible that a composition according to the disclosure contains two or more different types of monomers according to the general formula B-Aₙ. In some embodiments, the composition contains at least one type of monomer according to the general formula B-Aₙ, which has one or two olefinically unsaturated double bonds which are curable by ROMP. Suitable monomers are described, for example, in great detail in US Patent Publication No. 2009/00884 (Luchterhandt et al.).

The polymerizable component may also contain hydroxyl groups and ethylenically unsaturated groups in a single molecule. Examples of such materials include hydroxyalkyl (meth)acrylates, such as 2-hydroxyethyl (meth)acrylate and 2-hydroxypropyl (meth)acrylate; glycerol mono- or di-(meth)acrylate; trimethylolpropane mono- or di-(meth)acrylate; pentaerythritol mono-, di-, and tri-(meth)acrylate; sorbitol mono-, di-, tri-, tetra-, or penta-(meth)acrylate; and 2,2-bis[4-(2-hydroxy-3-methacryloxypropoxy)phenyl]propane (bisGMA). Suitable ethylenically unsaturated compounds are available from a wide variety of commercial sources, such as Sigma-Aldrich, St. Louis. Mixtures of ethylenically unsaturated compounds can be used if desired.

In certain embodiments, the polymerizable component may include, bisGMA, UDMA (urethane dimethacrylate), GDMA (glycerol dimethacrylate), TEGDMA (triethyleneglycol dimethacrylate), bisEMA6 as described in U.S. Pat. No. 6,030,606 (Holmes), phenoxyethylmethacrylate, and/or NPGDMA (neopentylglycol dimethacrylate). The polymerizable component may include combinations of these hardenable components. In one embodiment, the polymerizable component of at least one polymeric layer includes a combination of UDMA and phenoxyethylmethacrylate.

In some embodiments, the polymerizable component may include one or more ethylenically unsaturated compounds with acid functionality. As used herein, ethylenically unsaturated compounds “with acid functionality” is meant to include monomers, oligomers, and polymers having ethylenic unsaturation and acid and/or acid-precursor functionality. Acid-precursor functionalities include, for example, anhydrides, acid halides, and pyrophosphates. The acid functionality can include carboxylic acid functionality, phosphoric acid functionality, phosphonic acid functionality, sulfonic acid functionality, or combinations thereof.

Ethylenically unsaturated compounds with acid functionality include, for example, α,β-unsaturated acidic compounds such as glycerol phosphate mono(meth)acrylates, glycerol phosphate di(meth)acrylates, hydroxyethyl (meth)acrylate (e.g., HEMA) phosphates, bis((meth)acryloxyethyl) phosphate, ((meth)acryloxypropyl) phosphate, bis((meth)acryloxypropyl) phosphate, bis((meth)acryloxy)propyloxy phosphate, (meth)acryloxyhexyl phosphate, bis((meth)acryloxyhexyl) phosphate, (meth)acryloxyoctyl phosphate, bis((meth)acryloxyoctyl) phosphate, (meth)acryloxydecyl phosphate, bis((meth)acryloxydecyl) phosphate, caprolactone methacrylate phosphate, citric acid di- or tri-methacrylates, poly(meth)acrylated oligomaleic acid, poly(meth)acrylated polymaleic acid, poly(meth)acrylated poly(meth)acrylic acid, poly(meth)acrylated polycarboxyl-polyphosphonic acid, poly(meth)acrylated polychlorophosphoric acid, poly(meth)acrylated polysulfonate, poly(meth)acrylated polyboric acid, and the like, may be used as components in the hardenable component system. Also monomers, oligomers, and polymers of unsaturated carbonic acids such as (meth)acrylic acids, aromatic (meth)acrylated acids (e.g., methacrylated trimellitic acids), and anhydrides thereof can be used. Certain embodiments of the composition of the present disclosure include an ethylenically unsaturated compound with acid functionality having at least one P-OH moiety.

Certain of these compounds are obtained, for example, as reaction products between isocyanatoalkyl (meth)acrylates and carboxylic acids. Additional compounds of this type having both acid-functional and ethylenically unsaturated components are described in U.S. Pat. No. 4,872,936 (Engelbrecht) and U.S. Pat. No. 5,130,347 (Mitra). A wide variety of such compounds containing both the ethylenically unsaturated and acid moieties can be used. Mixtures of such compounds can be used if desired. Additional ethylenically unsaturated compounds with acid functionality include, for example, polymerizable bisphosphonic acids as disclosed for example, in U.S. Patent Application Publication No. 2009-0075239 (Abuelyaman); AA:ITA:IEM (copolymer of acrylic acid:itaconic acid with pendent methacrylate made by reacting AA:ITA copolymer with sufficient 2-isocyanatoethyl methacrylate to convert a portion of the acid groups of the copolymer to pendent methacrylate groups as described, for example, in Example 11 of U.S. Pat. No. 5,130,347 (Mitra)); and those recited in U.S. Pat. No. 4,259,075 (Yamauchi et al.), U.S. Pat. No. 4,499,251 (Omura et al.), U.S. Pat. No. 4,537,940 (Omura et al.), U.S. Pat. No. 4,539,382 (Omura et al.), U.S. Pat. No. 5,530,038 (Yamamoto et al.), U.S. Pat. No. 6,458,868 (Okada et al.), and European Pat. Application Publication Nos. EP 712,622 (Tokuyama Corp.) and EP 1,051,961 (Kuraray Co., Ltd.).

Compositions of the present disclosure can also include combinations of ethylenically unsaturated compounds with acid functionality as described, for example, in U.S. Patent Application Publication No. 2007/0248927 (Luchterhandt et al.). The compositions may also include a mixture of ethylenically unsaturated compounds both with and without acid functionality.

Polymerizable components may also include flexible monomers and multimethacrylate oligomers, including but not limited to phenoxyethylmethacrylate, trimethylcyclohexylmethacrylate, C8-C18 monomethacrylates, PEGDMA (polyethyleneglycol dimethacrylate having a molecular weight of approximately 400), aliphatic urethane methacrylates, aliphatic polyester urethane methacrylates, aliphatic polyester triurethane acrylates. Further contemplated are reactions products of isocyanatoethylmethacrylate with polytetramethylene ether diols and/or polycaprolactone polyols. In certain embodiments, the flexible monomers and/or oligomers have a glass transition temperature of no greater than 60 degrees Celsius.

Adding the monomers and multimethacrylate oligomers to a hardenable composition may create a composition having improved flexibility as evidenced by, for example, having at least a 3% elongation to break or ability to bend around at least an 8 mm mandrel. In certain preferred embodiments, the hardenable compositions deposited on wall surfaces below the height of contour include a flexible monomer or oligomer.

An exemplary self-cure system comprising aliphatic polyisocyanates is described in U.S. Pat. Nos. 7,189,429 and 6,730,353 (Robinson). The first part of this two-part system includes one or more aliphatic polyisocyanates. Suitable polyisocyanates include derivatives of hexamethylene-1,6-diisocyanate; 2,2,4-trimethylhexamethylene diisocyanate; isophorone diisocyanate; and 4,4′dicyclohexylmethane diisocyanate. Preferred polyisocyanates are the uretdione, biuret and isocyanurate trimer of hexamethylene-1,6-diisocyanate, with the uretdione being particularly preferred.

The preferred polyisocyanates have an isocyanate content of 15 to 30%, with an isocyanate content of 20 to 25% being particularly preferred. The aliphatic polyisocyanates may further be blended with one or more amine reactive resins and/or non-reactive resins.

The second part of a two-part coating system comprises one or more polyamines. The one or more polyamines are preferably aromatic. Suitable polyamines include diethyl toluenediamine; dimethylthio toluenediamine; 4,4′-methylenebis (2-isopropyl-6-methylaniline); and 4,4′-methylenebis (3-chloro-2,6-diethylaniline). The polyamines may further be blended with polyhydric alcohol. The polyhydric alcohol compounds can be polyester or polyether polyols containing at least two hydroxyl groups per molecule. Branched polyether-esters are particularly useful.

In another embodiment of the two-part coating system, the aromatic polyamines may be blended with oligomeric polyamines. Suitable compounds include poly (oxypropylene) diamines, poly (oxypropylene) triamines, poly (oxytetramethylene)-di-p-aminobenzoates.

Additional flexible components suitable for use in certain two-part systems include polyTHF, polyethyleneoxide, and polypropylene oxide.

### Initiator Systems

In certain embodiments, the hardenable compositions of the present disclosure are photopolymerizable, i.e., the hardenable compositions contain a photopolymerizable component and a photoinitiator system that upon irradiation with actinic radiation initiates the polymerization (or hardening) of the composition. Such photopolymerizable compositions can be free radically polymerizable or cationically polymerizable.

Suitable photoinitiators (i.e., photoinitiator systems that include one or more compounds) for polymerizing free radically photopolymerizable compositions include binary and tertiary systems. Typical tertiary photoinitiators include an iodonium salt, a photosensitizer, and an electron donor compound as described in U.S. Pat. No. 5,545,676 (Palazzotto et al.). Suitable iodonium salts are the diaryl iodonium salts, e.g., diphenyliodonium chloride, diphenyliodonium hexafluorophosphate, diphenyliodonium tetrafluoroborate, and tolylcumyliodonium tetrakis(pentafluorophenyl)borate. Suitable photosensitizers are monoketones and diketones that absorb some light within a range of 400 nm to 520 nm (preferably, 450 nm to 500 nm). Particularly suitable compounds include alpha diketones that have light absorption within a range of 400 nm to 520 nm (even more preferably, 450 to 500 nm). Suitable compounds are camphorquinone, benzil, furil, 3,3,6,6-tetramethylcyclohexanedione, phenanthraquinone, 1-phenyl-1,2-propanedione and other 1-aryl-2-alkyl-1,2-ethanediones, and cyclic alpha diketones. Suitable electron donor compounds include substituted amines, e.g., ethyl dimethylaminobenzoate. Other suitable tertiary photoinitiator systems useful for photopolymerizing cationically polymerizable resins are described, for example, in U.S. Pat. No. 6,765,036 (Dede et al.).

Other useful photoinitiators for polymerizing free radically photopolymerizable compositions include the class of phosphine oxides that typically have a functional wavelength range of 380 nm to 1200 nm. Suitable phosphine oxide free radical initiators with a functional wavelength range of 380 nm to 450 nm are acyl and bisacyl phosphine oxides such as those described in U.S. Pat. No. 4,298,738 (Lechtken et al.), U.S. Pat. No. 4,324,744 (Lechtken et al.), U.S. Pat. No. 4,385,109 (Lechtken et al.), U.S. Pat. No. 4,710,523 (Lechtken et al.), and U.S. Pat. No. 4,737,593 (Ellrich et al.), U.S. Pat. No. 6,251,963 (Kohler et al.); and EP Application No. 0 173 567 A2 (Ying).

Commercially available phosphine oxide photoinitiators capable of free-radical initiation when irradiated at wavelength ranges of greater than 380 nm to 450 nm include bis(2,4,6-trimethylbenzoyl)phenyl phosphine oxide (IRGACURE 819, Ciba Specialty Chemicals, Tarrytown, N.Y.), bis(2,6-dimethoxybenzoyl)-(2,4,4-trimethylpentyl) phosphine oxide (CGI 403, Ciba Specialty Chemicals), a 25:75 mixture, by weight, of bis(2,6-dimethoxybenzoyl)-2,4,4-trimethylpentyl phosphine oxide and 2-hydroxy-2-methyl-1-phenylpropan-1-one (IRGACURE 1700, Ciba Specialty Chemicals), a 1:1 mixture, by weight, of bis(2,4,6-trimethylbenzoyl)phenyl phosphine oxide and 2-hydroxy-2-methyl-1-phenylpropane-1-one (DAROCUR 4265, Ciba Specialty Chemicals), and ethyl 2,4,6-trimethylbenzylphenyl phosphinate (LUCIRIN LR8893X, BASF Corp., Charlotte, N.C.).

Typically, the phosphine oxide initiator is present in the photopolymerizable composition in catalytically effective amounts, such as from 0.1 weight percent to 5.0 weight percent, based on the total weight of the unfilled composition.

Tertiary amine reducing agents may be used in combination with an acylphosphine oxide. Illustrative tertiary amines useful in the disclosure include ethyl 4-(N,N-dimethylamino)benzoate and N,N-dimethylaminoethyl methacrylate. When present, the amine reducing agent is present in the photopolymerizable composition in an amount from 0.1 weight percent to 5.0 weight percent, based on the total weight of the unfilled composition. Useful amounts of other initiators are well known to those of skill in the art.

In certain embodiments, the compositions of the present disclosure are chemically hardenable, i.e., the compositions contain a chemically hardenable component and a chemical initiator (i.e., initiator system) that can polymerize, cure, or otherwise harden the composition without dependence on irradiation with actinic radiation. Such chemically hardenable compositions are sometimes referred to as “self-cure” compositions.

In embodiments wherein the hardenable composition includes a monomer or oligomer curable by ROMP, suitable initiators include all substances which are able to initiate a ROMP polymerization in a curable composition. It is preferred that a polymer composition comprising an ROMP initiator is sufficiently chemically stable at ambient temperature, generally at room temperature or temperatures up to 60° C., providing unhindered preparation and molding of the formulation.

Suitable chemically stable initiators do not lead to an increase of viscosity of the composition of more than 10% during a minimum of 5 hours at temperatures below 50° C.

It is also preferred that a suitable initiator will cure the formulation within 24 hours at a temperature above 100° C. by ROMP reaction. Preferred initiators are metal complexes of ruthenium or osmium not bearing a carbene function. Examples of suitable initiators can be found in Castarlenas et al., Journal of Organometallic Chemistr, 663 (2002) 235-238 and in Hafner et al., Angew. Chem. 1997, 109, Nr. 19, S. 2213. Further preferred initiators are disclosed in U.S. Pat. No. 6,001,909 (Setiabudi) and US Patent Publication No. 2009/00884 (Luchterhandt et al.).

The chemically hardenable compositions may include redox cure systems that include a polymerizable component (e.g., an ethylenically unsaturated polymerizable component) and redox agents that include an oxidizing agent and a reducing agent.

Suitable polymerizable components, redox agents, optional acid-functional components, and optional fillers that are useful in the present disclosure are described in U.S. Pat. Publication Nos. 2003/0166740 (Mitra et al.) and 2003/0195273 (Mitra et al.).

The reducing and oxidizing agents should react with or otherwise cooperate with one another to produce free-radicals capable of initiating polymerization of the resin system (e.g., the ethylenically unsaturated component). This type of cure is a dark reaction, that is, it is not dependent on the presence of light and can proceed in the absence of light. The reducing and oxidizing agents are preferably sufficiently shelf-stable and free of undesirable colorization to permit their storage and use under typical dental conditions. They should be sufficiently miscible with the resin system (and preferably water-soluble) to permit ready dissolution in (and discourage separation from) the other components of the composition.

Useful reducing agents include ascorbic acid, ascorbic acid derivatives, and metal complexed ascorbic acid compounds as described in U.S. Pat. No. 5,501,727 (Wang et al.); amines, especially tertiary amines, such as 4-tert-butyl dimethylaniline; aromatic sulfinic salts, such as p-toluenesulfinic salts and benzenesulfinic salts; thioureas, such as 1-ethyl-2-thiourea, tetraethyl thiourea, tetramethyl thiourea, 1,1-dibutyl thiourea, and 1,3-dibutyl thiourea; and mixtures thereof. Other secondary reducing agents may include cobalt (II) chloride, ferrous chloride, ferrous sulfate, hydrazine, hydroxylamine (depending on the choice of oxidizing agent), salts of a dithionite or sulfite anion, and mixtures thereof. Preferably, the reducing agent is an amine.

Suitable oxidizing agents will also be familiar to those skilled in the art, and include but are not limited to persulfuric acid and salts thereof, such as sodium, potassium, ammonium, cesium, and alkyl ammonium salts. Additional oxidizing agents include peroxides such as benzoyl peroxides, hydroperoxides such as cumyl hydroperoxide, t-butyl hydroperoxide, and amyl hydroperoxide, as well as salts of transition metals such as cobalt (III) chloride and ferric chloride, cerium (IV) sulfate, perboric acid and salts thereof, permanganic acid and salts thereof, perphosphoric acid and salts thereof, and mixtures thereof.

It may be desirable to use more than one oxidizing agent or more than one reducing agent. Small quantities of transition metal compounds may also be added to accelerate the rate of redox cure. In some embodiments it may be preferred to include a secondary ionic salt to enhance the stability of the polymerizable composition as described in U.S. Pat. Publication No. 2003/0195273 (Mitra et al.).

The reducing and oxidizing agents are present in amounts sufficient to permit an adequate free-radical reaction rate. This can be evaluated by combining all of the ingredients of the composition except for the optional filler, and observing whether or not a hardened mass is obtained.

Typically, the reducing agent, if used at all, is present in an amount of at least 0.01% by weight, and more typically at least 0.1% by weight, based on the total weight (including water) of the components of the composition. Typically, the reducing agent is present in an amount of no greater than 10% by weight, and more typically no greater than 5% by weight, based on the total weight (including water) of the components of the unfilled composition.

Typically, the oxidizing agent, if used at all, is present in an amount of at least 0.01% by weight, and more typically at least 0.10% by weight, based on the total weight (including water) of the components of the composition. Typically, the oxidizing agent is present in an amount of no greater than 10% by weight, and more typically no greater than 5% by weight, based on the total weight (including water) of the components of the unfilled composition.

The reducing or oxidizing agents can be microencapsulated as described in U.S. Pat. No. 5,154,762 (Mitra et al.). This will generally enhance shelf stability of the composition, and if necessary permit packaging the reducing and oxidizing agents together. For example, through appropriate selection of an encapsulant, the oxidizing and reducing agents can be combined with an acid-functional component and optional filler and kept in a storage-stable state. Likewise, through appropriate selection of a water-insoluble encapsulant, the reducing and oxidizing agents can be combined with an fluoro-aluminosilicate (FAS) glass and water and maintained in a storage-stable state.

A redox cure system can be combined with other cure systems, including photoinitiator systems or with a composition such as described U.S. Pat. No. 5,154,762 (Mitra et al.).

In another embodiment of the present disclosure, the initiator system comprises free radical-generating thermal initiators. Thermal initiators include organic peroxides (e.g., benzoyl peroxide), azo compounds, quinones, nitroso compounds, acyl halides, hydrazones, mercapto compounds, pyrylium compounds, imidazoles, chlorotriazines, benzoin, benzoin alkyl ethers, diketones, phenones, and mixtures thereof. Examples of suitable thermal initiators are VAZO 52, VAZO 64 and VAZO 67 azo compound thermal initiators, all available from DuPont. Preferred thermal initiators include benzoyl peroxide, dicumylperoxide, and andazobisisobutyronitrile (AIBN).

### Nanofiller

The hardenable compositions of the disclosure can be formulated with one or more nanofillers that may impart desirable wear and aesthetic properties (e.g., tooth like color to mask the underlying metal). Suitable nanofillers include either acid reactive or non-acid reactive nanofillers and may include, but are not limited to silica; zirconia; oxides of titanium, aluminum, cerium, tin, yttrium, strontium, barium, lanthanum, zinc, ytterbium, bismuth, iron, and antimony; and combinations thereof. More typical nanofillers may include zirconia (ZrO₂); oxides of titanium (e.g., TiO₂), and oxides of yttrium (e.g., Y₂O₃); and other metal oxides with high refractive indices. In preferred embodiments, the nanofiller comprises an oxide of titanium. As used herein, “high refractive index” means a refractive index of typically at least 1.5, and more typically of at least 2.0. Titania and zirconia are particularly useful nanofillers, as they have very high refractive indices, and will require less weight of material than a lower refractive index material to match the refractive indices appropriately.

The nanofillers typically have an average particle size of at most 100 nanometers and more typically at most 50 nanometers. Such nanofillers typically have an average particle size of at least 2 nanometers, more typically at least 5 nanometers, and even more typically at least 10 nanometers. In some embodiments, the nanofiller is in the form of nanoclusters, typically at least 80 percent by weight nanoclusters. In other embodiments, the nanofiller is in the form of a combination of nanoparticles and nanoclusters. Often a portion of the surface of the nanofiller is silane treated or otherwise chemically treated to provide one or more desired physical properties. Additional suitable nanofillers are disclosed in U.S. Pat. No. 6,387,981 (Zhang et al.) and U.S. Pat. No. 6,572,693 (Wu et al.), U.S. Publication No. 2008/0293846 (Craig et al.), as well as International Publication Nos. WO 01/30305 (Zhang et al.), WO 01/30306 (Windisch et al.), WO 01/30307 (Zhang et al.), and WO 03/063804 (Wu et al.). Filler components described in these references include nanosized silica particles, nanosized metal oxide particles, and combinations thereof.

Typically, the nanofillers of the present disclosure are non-pyrogenic fillers, however pyrogenic fillers can be added as optional additives to the dental compositions.

The amount of nanofiller should be sufficient to provide a hardenable composition having desirable mixing and handling properties before hardening and good physical and optical properties after hardening. Typically, the nanofiller represents at least 0.1 wt-%, more typically at least 5 wt-% or 10 wt-%, and most typically at least 20 wt-% based on the total weight of the composition. Typically, the nanofiller represents at most 70 wt-%, more typically at most 50 wt-%, and most typically at most 40 wt-%, based on the total weight of the composition.

### Pigments & Other Fillers

The hardenable compositions of the present disclosure may further include pigments. A tooth-colored pigment can be achieved, for example, by using a mixture of titanium dioxide and iron oxide. The titanium dioxide and iron oxide pigments can be used in varying amounts depending on the shade of tooth enamel desired to be reproduced. For example, 15 wt-% to 55 wt-% titanium dioxide, and 0.01 wt-% to 4.5 wt-% iron oxide, based on the total weight of the hardenable composition, give a natural tooth enamel appearance to the coating. Additional pigments or colorants can be optionally added to the starting coating powders to color-match the polymeric coating to a desired tooth color.

In addition to the nanofiller and pigment components, the hardenable compositions of the present disclosure can also optionally include one or more other fillers. Such fillers may be selected from one or more of a wide variety of materials suitable for the use in dental and/or orthodontic compositions.

The other filler can be an inorganic material. It can also be a crosslinked organic material that is insoluble in the resin component of the composition, and is optionally filled with inorganic filler. The filler should in any event be nontoxic and suitable for use in the mouth. The filler can be radiopaque or radiolucent. The filler typically is substantially insoluble in water.

Examples of suitable inorganic fillers are naturally occurring or synthetic materials including, but not limited to: quartz; nitrides (e.g., silicon nitride); glasses derived from, for example, Zr, Sr, Ce, Sb, Sn, Ba, Zn, and Al; feldspar; borosilicate glass; kaolin; talc; titania; low Mohs hardness fillers such as those described in U.S. Pat. No. 4,695,251 (Randklev); and silica particles (e.g., submicron pyrogenic silicas such as those available under the trade designations AEROSIL, including “OX 50,” “130,” “150” and “200” silicas from Degussa A G, Hanau, Germany and CAB-O-SIL M5 and TS 720 silica from Cabot Corp., Tuscola, Ill.). Examples of suitable organic filler particles include filled or unfilled pulverized polycarbonates, polyepoxides, and the like.

Suitable non-acid-reactive filler particles are quartz, submicron silica, and non-vitreous microparticles of the type described in U.S. Pat. No. 4,503,169 (Randklev). Mixtures of these non-acid-reactive fillers are also contemplated, as well as combination fillers made from organic and inorganic materials. The surface of the filler particles can also be treated with a coupling agent. Suitable coupling agents include gamma-methacryloxypropyltrimethoxysilane, gamma-mercaptopropyltriethoxysilane, gamma-aminopropyltrimethoxysilane, and the like. Examples of useful silane coupling agents are those available from Crompton Corporation, Naugatuck, Conn., as SILQUEST A-174 and SILQUEST A-1230.

### Other Additives

Optionally, compositions of the present disclosure may contain solvents (e.g., alcohols (e.g., propanol, ethanol), ketones (e.g., acetone, methyl ethyl ketone), esters (e.g., ethyl acetate), other nonaqueous solvents (e.g., dimethylformamide, dimethylacetamide, dimethylsulfoxide, 1-methyl-2-pyrrolidinone)), or mixtures thereof.

Compositions of the present disclosure may further include core-shell polymer compounds. A core-shell compound includes a soft core comprising a rubber or elastomeric polymer surrounded by a shell comprising a more rigid polymer. Such compounds may reduce the shrinkage of the composition on polymerization. Exemplary core-shell polymer compounds are discussed in U.S. Publication No. 2005/0124762. (Cohen et al.).

If desired, the compositions of the disclosure may contain additives such as indicators, dyes (including photobleachable dyes), inhibitors, accelerators, viscosity modifiers, wetting agents, antioxidants, tartaric acid, chelating agents, buffering agents, stabilizers, diluents, and other similar ingredients that will be apparent to those skilled in the art. Surfactants, for example, nonionic surfactants, cationic surfactants, anionic surfactants, and combinations thereof, may optionally be used in the compositions. Useful surfactants include non-polymerizable and polymerizable surfactants. Additionally, medicaments or other therapeutic substances can be optionally added to the hardenable compositions. Examples include, but are not limited to, fluoride sources, whitening agents, anticaries agents (e.g., xylitol), remineralizing agents (e.g., calcium phosphate compounds and other calcium sources and phosphate sources), enzymes, breath fresheners, anesthetics, clotting agents, acid neutralizers, chemotherapeutic agents, immune response modifiers, thixotropes, polyols, anti-inflammatory agents, antimicrobial agents, antifungal agents, agents for treating xerostomia, desensitizers, and the like, of the type often used in dental compositions.

Combination of any of the above additives may also be employed. The selection and amount of any one such additive can be selected by one of skill in the art to accomplish the desired result without undue experimentation.

### Exemplary Compositions of the Basecoat, Hardcoat, and Clearcoat

### Basecoat

Suitable hardenable compositions for use as a basecoat typically include a polymerizable component, a photoinitiator, a thermal initiator, a nanofiller, a pigment, and a filler. Particularly suitable polymerizable components for use in the basecoat include UDMA, phenoxyethylmethacrylate, other flexible monomers and multi-methacrylate oligomers, and combinations thereof. For basecoat hardenable compositions of the present disclosure that include fillers (nanofillers & other fillers) the compositions may include at least 1% by weight, more preferably at least 2% by weight, and most preferably at least 5% by weight filler, based on the total weight of the composition. For such embodiments, compositions of the present disclosure preferably include at most 75% by weight, more preferably at most 65% by weight, and even more preferably at most 55% by weight filler, based on the total weight of the composition.

### Hardcoat

Suitable hardenable compositions for use as a hardcoat typically include include a polymerizable component, a photoinitiator, a thermal intiator, a nanofiller, a pigment, and a filler. In certain embodiments, the polymerizable component of the hardcoat is the same or similar to the polymerizable component of the basecoat. In particularly useful hardcoat compositions, the filler content is greater than that of the basecoat. Regarding filler (both nano & other filler), hardenable compositions suitable for use as a hardcoat include at most 95% by weight, more preferably at most 85% by weight, and even more preferably at most 75% by weight other filler, based on the total weight of the composition.

### Clearcoat

Suitable compositions for use the clearcoat polymer layer typically include a polymerizable component, a photoinitiator, and a thermal initiator. Particularly suitable polymerizable components for use in the clearcoat include UDMA, phenoxyethylmethacrylate, and combinations thereof. As the designation suggests, the clearcoat may be near translucent and may lack a pigment in some embodiments. The clearcoat may include a low concentration of nanofiller and/or other filler.

When a polymer composition includes an ethylenically unsaturated compound and at least one filler, the ethylenically unsaturated compounds are generally present in an amount of at least 15% by weight, more typically at least 25% by weight, and most typically at least 35% by weight ethylenically unsaturated compounds, based on the total weight of the filled composition. The compositions of the present disclosure typically include at most 95% by weight, more typically at most 90% by weight, and most typically at most 80% by weight ethylenically unsaturated compounds, based on the total weight of the filled composition.

When the composition includes an ethylenically unsaturated compound with acid functionality, it is generally present in an amount of at least 1% by weight, more typically at least 3% by weight, and most typically at least 5% by weight ethylenically unsaturated compounds with acid functionality, based on the total weight of the unfilled composition. The compositions of the present disclosure typically include at most 80% by weight, more typically at most 70% by weight, and most typically at most 60% by weight ethylenically unsaturated compounds with acid functionality, based on the total weight of the unfilled composition.

### Preparation of Polymer Compositions

The polymer compositions useful in the present disclosure can be prepared by combining all the various components using conventional mixing techniques. The resulting composition may optionally contain fillers, solvents, water, and other additives as described herein. Typically, photopolymerizable compositions of the disclosure are prepared by simply admixing, under “safe light” conditions, the components of the inventive compositions. Suitable inert solvents may be employed if desired when affecting this mixture. Any solvent may be used which does not react appreciably with the components of the inventive compositions. Examples of suitable solvents include acetone, dichloromethane, isopropyl alcohol, ethanol, and butanone.

The amounts and types of each ingredient in the polymer compositions may be adjusted to provide the desired physical and handling properties before and after polymerization. For example, the polymerization rate, polymerization stability, fluidity, compressive strength, tensile strength and durability of the dental material typically are adjusted in part by altering the types and amounts of polymerization initiator(s) and the loading and particle size distribution of filler(s). Such adjustments typically are carried out empirically based on previous experience with dental materials.

The components of the composition can be included in a kit, where the contents of the composition are packaged to allow for storage of the components until they are needed.

### Coating the Dental Article

Prior to depositing the multilayer polymeric coating, the target surface(s) (i.e., the portion of the article to be coated) of the dental article may be primed (e.g., abraded, etched, particle deposition) to enhance the bond between the coating and the metal substrate surface. In one embodiment, the target surfaces may be first sandblasted as known in the art by, for example, the method shown in U.S. Pat. No. 5,024,711 to Gasser et al. The target surfaces may be microblasted with an aluminum oxide sand, such as ROCATEC Pre, available from 3M ESPE. In some embodiments, the target surface may be subsequently treated with a silica-modified aluminum oxide, such as ROCATEC Plus, also available from 3M ESPE. Alternatively, the outer surface may be treated with ROCATEC Plus or other silica-modified aluminum oxide without prior treatment with ROCATEC Pre.

In another embodiment, the target surface of the dental article is primed or otherwise modified by etching with a strong acid such as hydrochloric acid. Additional useful etchants include nitric acids, hydrofluoric acids, ferric chlorides, sodium hydroxides, and combinations thereof. Although not wishing to be bound by theory, the roughening (i.e., priming) of the target surface by acid-etch or sandblast creates greater surface area and may strengthen the multilayer polymeric coating bond to the chosen metal substrate.

The target surface may also be coated with a diamond-like glass (DLG), such as those described in U.S. Pat. No. 6,696,157 to David et al, as part of the priming process. DLG is an amorphous carbon system including a substantial quantity of silicon and oxygen that exhibits diamond-like properties. DLG may be deposited onto at least a portion of the target surface by plasma deposition or other techniques known to those having skill in the art.

Once the dental article is primed (e.g., abraded, etched, deposited) an additional bonding layer may be deposited on the surface. The dental article may undergo silanization by, for example, spray or bath after the sandblast or acid-etch abrasion procedure. Exemplary useful silanes include, but are not limited to, 3M ESPE Sil, available from 3M ESPE and methacryloxypropyltrimethoxy silane, available under the trade name GENIOSIL GF-31 from Wacker Chemical, Adrian, Mich. Alternatively or additionally, the primed dental article may be exposed (e.g., by spray or bath) to Zirconate coupling agents available from Kenrich Petrochemicals, Bayonne, N.J.

If a hardenable composition includes phosphorylated monomers, it may be unnecessary to include a bonding layer on the target surface of the dental article after priming.

Once the target surface of the dental article has been primed and optionally treated with a bonding layer as described above (i.e., silanized or treated with Zirconate coupling agents), the basecoat hardenable composition may be deposited according to methods well known in the art.

The layers of hardenable composition can be applied using conventional techniques, including, but not limited to, dip coating, spray coating, brush coating, spin coating, and lithographic printing. In preferred embodiments, the hardenable compositions are deposited on the surface of the crown and other polymeric layers prior to curing.

Thickness gradients and coatings substantially above the height of contour may be created, for example, by directional spraying only the targeted portion of the crown with any one of the hardenable compositions so that substantially none of the particular coating is applied below the height of contour.

In embodiments wherein the hardenable composition includes a photoinitiator, a curing light, such as a VISILUX Model 2500 blue light gun (available from 3M Co., St. Paul, Minn.) or a ELIPAR FREELIGHT 2 LED CURING LIGHT (available from 3M ESPE Dental Products, St. Paul, Minn.) is generally used to irradiate the hardenable compositions and initiate hardening (i.e., polymerization). Alternatively, an irradiating chamber may be used, such as a VISIO Beta Vario Light Curing Unit (available from 3M ESPE Dental Products, St. Paul, Minn). In certain embodiments, the first and second hardenable compositions are at least partially cured after they have been deposited on the surface. Without wishing to be bound by theory, the partial curing of the hardenable compositions facilitates the bonding of additional layers deposited thereon.

In embodiments wherein the hardenable composition comprises a thermal initiator, heat may be used to initiate the hardening of free radically active groups. Examples of heat sources suitable for curing include inductive, convective, and radiant heat sources. Thermal sources should be capable of generating temperatures of at least 40° C. and at most 150° C. under normal conditions or at elevated pressure.

Once the basecoat, hardcoat, and clearcoat have been deposited on at least portions of the crown surface, the three compositions are hardened to the extent possible (i.e., fully cured) according to techniques described above. In certain embodiments wherein the hardenable composition comprises a photoinitiator and a thermal initiator, the curing process includes both irradiation and exposure to heat.

As noted above, the multilayer polymeric coatings of the present disclosure provides desirable aesthetic properties, such as close approximation of tooth color. The following parameters form the basis of the color determination of the coated dental article: Opacity value 0: Measure of the transparency (0% is completely transparent, 100% is opaque), L*-value: Brightness (100: complete reflection; 0; no reflection); a*-value: Red-green shift (+a: red; -a: green); b*-value: yellow-blue shift (+b: yellow; -b: blue).

The L*-value of a coated dental article is preferably greater than 60, more preferably greater than 75, and even more preferably greater than 80. The multilayer polymeric coating may also be tailored to the shades on the VITA shade guide. The a* value of a coated dental article is within the range of −3 to 13. The b* value of a coated dental article is within the range of 10 to 35.

Certain embodiments of the multilayer polymeric coatings can provide desirable flexibility. One method of determining flexibility includes the bending of a 150 micron thick metal coupon around a mandrel. The metal coupon is preferably made of the same metal used on the outer surface of the uncoated dental article and includes a deposited multilayer polymeric coating. Preferably, a coated coupon can bend 180 degrees around an 8 millimeter mandrel without cracking of the coating. More preferably, a coated coupon can bend around a 4 millimeter mandrel, and even more preferably a 2 millimeter mandrel without cracking of the coating.

In another embodiment of the disclosure, a crown or a plurality of crowns (potentially of varying sizes) may be provided in a kit with the components of the multilayer polymer coating. The crown may preferably be provided in the kit pre-primed (i.e., the surface has been roughened according to techniques described below). The kit may further include the basecoat, hardcoat, and clearcoat hardenable dental compositions. Such a kit may allow a practitioner to tailor the particular location and aesthetics of the coating on the crown(s). The kit may also include other components including, but not limited to, cements, brushes, and other tools to apply the coatings.

### Illustrative Embodiments

1. A method for coating a medical article comprising: providing a dental crown comprising a metal substrate; depositing a coating, said depositing comprising; depositing a first hardenable composition on at least a portion of the outer surface of the crown, wherein said depositing forms a first polymer layer; depositing a second hardenable composition on at least a portion of the first polymer layer, wherein depositing the second hardenable composition forms a second polymer layer, and wherein each of the first and second hardenable compositions comprise a polymerizable component, wherein one of the first and second hardenable compositions is deposited substantially above the height of contour.

2. The method of embodiment 1, further comprising priming at least a portion of a surface of the crown.

3. The method of embodiment 2, wherein priming at least a portion of a surface comprises: depositing a layer of diamond-like glass on at least a portion of the surface.

4. The method of embodiment 2, wherein priming at least a portion of a surface comprises: exposing at least a portion of the surface to a strong acid or sandblasting at least a portion of the surface.

5. The method of any one of embodiments 1 to 4, further comprising applying a bonding layer to at least a portion of the outer surface, wherein the bonding layer is selected from the group consisting of: silane and zirconate.

6. The method of embodiments 1-5, further comprising depositing a third hardenable composition, wherein depositing a third hardenable composition forms a third polymer layer, and wherein the third hardenable composition comprises a polymerizable component.

7. The method of embodiment 6, wherein each polymerizable component of the first, second, and third polymerizable components comprises a (meth)acrylate monomer.

8. The method of embodiments 1-7, wherein at least one of the first, second, and third polymerizable components is selected from the group consisting of phenoxoyethyl methacrylate, urethane dimethacrylate, polyethylene glycol methacrylate, polypropylene glycol methacrylate, triethyleneglycol dimethacrylate, the diglycidyl methacrylate of bisphenol A, and combinations thereof.

9. The method of embodiments 1-8, wherein at least one of the first, second, or third polymerizable components is a compound according to the formula:

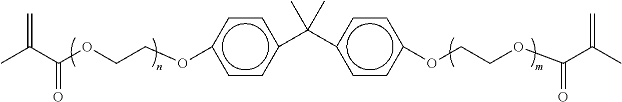

wherein m+n is between 5 and 8.

10. The method of embodiments 1-9, wherein at least one of the first, second and third hardenable compositions comprises an initiator system, said initiator system comprising an photoinitiator and a thermal initiator.

11. The method of embodiments 1-10, wherein the first hardenable composition comprises filler, and wherein the filler is present at no greater than 85 weight percent by weight of the composition.

12. The method of embodiments 1-11, wherein the second hardenable composition comprises filler, and wherein the filler is present at no greater than 60 weight percent by weight of the composition.

13. The method of embodiment 12, wherein the filler comprises a fumed silica particle.

14. The method of embodiments 1-13, wherein at least one of first or second hardenable compositions further comprises a pigment selected from the group consisting of titanium dioxide, iron oxide, and combinations thereof.

15. The method of embodiment 14, wherein the pigment is present in the first hardenable composition at a weight of no greater than 55% by weight of the first hardenable composition.

16. The method of embodiments 1-15, wherein the coating has a thickness on the surface above the height of contour of no greater than 300 microns.

17. The method of embodiment 16, wherein the thickness of the coating at location proximate a cervical margin of the crown is less than the thickness of the coating above the height of contour.

18. The method of embodiments 1-17, wherein the coating comprises a thickness gradient in at least one of the first and second polymeric layers.

19. The method of embodiments 1-18, further comprising irradiating at least a portion of the surface; and exposing at least a portion of the surface to heat.

20. A coated dental article comprising: a dental crown having a height of contour; a first layer of material disposed on at least a portion of the outer surface of the crown, wherein the first layer comprises a first hardened dental composition; and a second layer of material disposed on at least a portion of the first layer, wherein the second layer comprises a second hardened dental composition, wherein either the first or second layer is disposed on at least a portion of the outer surface substantially above the height of contour.

21. The dental article of embodiment 20 further comprising a third layer of material disposed proximate the second layer, wherein the third layer comprises a third hardened dental composition.

22. The dental article of embodiments 20-21, wherein the dental crown is a stainless steel crown.

23. The dental article of embodiment 20-22, wherein the first layer comprises a thickness of no greater than 450 microns.

24. The dental article of embodiment 20-23, wherein the second layer comprises a thickness of no greater than 450 microns.

25. The dental article of embodiment 21-24, wherein the third layer comprises a thickness of no greater than 50 microns.

26. The dental article of any of the preceding embodiments, wherein the metallic crown comprises a gingival-labial outer edge region and a gingival-lingual outer edge region, and wherein the second layer is not disposed on a portion of either the gingivallabial outer edge region or the gingival-lingual outer edge region.

27. The dental article of embodiments 21-26, wherein the first hardened composition comprises a first polymerizable component, a pigment, and a filler; the second hardened composition comprises a second polymerizable component, a pigment, and a filler; and the third hardened composition comprising a third polymerizable component.

28. The dental article of embodiment 27, wherein each polymerizable component of the first, second, and third polymerizable components comprises at least one (meth)acrylate monomer.

29. The dental article of embodiment 27, wherein at least one polymerizable component of the first, second, and third polymerizable components comprises an ethlenically unsaturated compound.

30. The article of embodiment 27, wherein at least one polymerizable component is selected from the group consisting of phenoxoyethyl methacrylate, urethane dimethacrylate, polyethylene glycol methacrylate, polypropylene glycol methacrylate, triethyleneglycol dimethacrylate, the diglycidyl methacrylate of bisphenol A, and combinations thereof.

31. The article of embodiments 27-30, wherein at least one polymerizable component comprises a core-shell polymer compound.

32. The article of any one of embodiments 27-31, wherein at least one of the first, second, and third polymerizable components is the same as at least another of the first, second, and third polymerizable components.

33. The article of embodiments 27-32, wherein the filler of the first hardened composition is present at no greater than 85 weight percent by weight of the composition.

34. The article of embodiments 27-33, wherein the pigment of the first hardened compositions is present at a weight of no greater than 55% by weight of the polymer.

35. The article of embodiments 27-34, wherein the filler of the second hardened composition is present at no greater than 85 weight percent by weight of the composition.

36. The article of embodiment 27-35, wherein the pigment of the second hardened composition is present at a weight of no greater than 55% by weight of the polymer.

37. The article of embodiments 27-36, wherein the pigment is selected from the group consisting of titanium dioxide, iron oxide, and combinations thereof

38. The article of embodiments 27-37, wherein at least one of the first, second, and third hardened compositions further comprise an initiator system comprising a photoinitiator and a thermal initiator.

39. The article of embodiments 27-38, wherein the thickness of all layers on the surface for contacting the opposing dentition is no greater than 500 microns.

40. The article of embodiments 27-39, further comprising a thickness gradient in at least one of the polymeric layers.

41. The article of embodiments 27-40, further comprising a diamond-like glass layer deposited on at least a portion of the outer surface.

42. The article of embodiment 27-41, further comprising a bonding layer deposited on at least a portion of the outer surface, wherein the bonding layer comprises a component selected from the group consisting of silane and zirconate.

43. The article of embodiment 27-42, wherein at least one polymerizable component of the first, second, and third polymerizable components comprises a flexible monomer or multi(meth)acrylate oligomer.

44. A kit comprising: a crown; a first hardenable composition comprising a first polymerizable component, a first pigment, and a first filler; a second hardenable composition comprising a second polymerizable component, a second pigment, and a second filler; optionally a third hardenable composition comprising a second polymerizable component, wherein the first, second, and third polymerizable components comprise at least one (meth)acrylate monomer; and at least one of a cement, a brush, and instructions for application of the hardenable dental compositions.

45. The kit of embodiment 44, wherein the crown further comprises a diamond-like glass layer on at least a portion of the outer surface.

46. The kit of embodiments 44-45, wherein at least one polymerizable component of the first, second and third polymerizable components is selected from the group consisting of phenoxoyethyl methacrylate, urethane dimethacrylate, polyethylene glycol methacrylate, polypropylene glycol methacrylate, triethyleneglycol dimethacrylate, the diglycidyl methacrylate of bisphenol A, and combinations thereof.

Objects and advantages of this invention are further illustrated by the following examples, but the particular materials and amounts thereof recited in these examples, as well as other conditions and details, should not be construed to unduly limit this invention. Unless otherwise indicated, all parts and percentages are by weight.

### EXAMPLES

TABLE 1
Glossary

| Abbreviation | Chemical description (supplier, location) |
|---|---|
| Silica/zirconia cluster | Refers to silane-treated zirconia/silica |
| | nanocluster filler prepared essentially as |
| | described in U.S. Pat. No. 6,730,156 |
| | (Preparatory Example A (line 51-64) and |
| | Example B (column 25 line 65 through |
| | column 26 line 40). |
| UDMA | Diurethane Dimethacrylate (Rohm Tech, |
| | Inc. (Malden, MA) |
| SR340 | 2-phenoxyethyl methacrylate (Sartomer |
| | Co., Inc., Exton, PA) |
| GF-31 | 3-methacryloxypropyltrimethoxy silane |
| | (Wacker Chemie, Germany) |
| Dibutyl tin dilaurate | (Sigma-Aldrich, St. Louis, MO) |
| TiO2 | Titanium dioxide, R960 (Dupont, |
| | Wilmington, DE) |
| TS-720 | Surface treated fumed silica, (Cabot, |
| | Boston, MA) |
| Aerosil R972 | Surface treated fumed silica (Degussa, |
| | Germany) |
| Aerosil R8125 | Surface treated fumed silica (Degussa, |
| | Germany) |
| PolyTHF diol | Poly tetrahydrofuran diol T2000, (Invista, |
| | Wichita, KS) |
| Irgacure 819 | Bis(2,4,6- |
| | Trimethylbenzoyl)phenylphosphine oxide |
| | (Ciba Inc., Tarrytown, NY) |
| CC59 | Variquat (EMCOL) CC59 alkoxylated |
| | ammonium phosphate cationic surfactant, |
| | (Evonik Goldschmidt) |
| IEM | 2-isocyanatoethyl methacrylate (Sigma- |
| | Aldrich, St. Louis, MO) |
| DCP | Dicumyl peroxide (Pfaltz & Bauer, |
| | Waterbury, CT) |
| BYK 2155 | Wetting and dispersing additive (BYK |
| | USA Inc., Wallingford, CT) |
| Dibenzoyl peroxide | Sigma Aldrich, St. Louis, MO |
| Z250 | Dental Composite (3M, St. Paul, MN) |

### Test Methods

### Flexibility

Samples of coating compositions were applied to sheets of 150 μm thick stainless steel to achieve thicknesses of approximately 25, 50 and 75 μm. The resulting samples were bent through 180° around a 2 mm diameter mandrel using finger pressure. During the bending process, the angle was measured for which a crack first appeared for each thickness of each example composition. A material is considered to pass if it is successfully bent through 180° without cracking A minimum of 3 replicates were carried out for each thickness and composition, and the measured values were averaged.

### Two-Body Wear (“Artificial Mouth” Model)

This test was designed to utilize a Servo-Hydraulic Model of the “Artificial Mouth” (University of Minnesota Dental Research Center for Biomaterials and Biomechanics; MTS Corporation, Minneapolis, Minn.) to measure the coating wear of various powder-coated metal dental crowns. The “Artificial Mouth” Model was designed to simulate chewing action and is described in R. Delong and W. H. Douglas, “The Development of an Artificial Oral Environment of Testing of Restoratives,” J. Dental Research, No. 62, Pages 32-36, 1983. The “Artificial Mouth” Model was configured such that the test coated crown sample (maxillary second molar) was opposed by a cusp from an extracted human third molar. During the test run, the antagonist slid against the labial surface of the coated crown at 16 Newtons force and at 4 cycles per second. The test was stopped after every 5000 cycles and the point of contact on the coated crown (lingual surface) was photographed with a high-resolution digital camera. The test was then continued for a total of 25000 cycles. The resulting digital photographs were closely scrutinized and rated on the basis of the features of the wear area and on the degree of penetration of the coating (that is clearly visible due to the underlying exposed metal crown).

The photograph assessments were rated according to the following scale:

1. Extensive visible metal exposure

2. Medium visible metal exposure

3. Minimum visible metal exposure

4. Minimum visible coating surface wear (no visible metal exposed)

5. No visual wear

### Three Body Wear

In order to test the wear resistance of certain compositions, samples were constructed and tested according to the ACTA method described by P. Pallav, C. L. Davidson, and A. J. DeGee in J Pros Dent 59 (1988) (4), pp. 426-429, with minor modifications (ACTA wear system, based on a Perthometer profiler and ACTA Wear software version 3). Segments including certain compositions were attached to a brass wear wheel, and subjected to the 3-body wear process for 200000 cycles. Profiles of the wear wheel segments were taken at 40000 cycle intervals, and the slope of the resulting loss of material versus number of cycles was calculated and compared to that of a standard dental composite, 3M-ESPE Z250, in the same wear wheel.

### Trimming and Crimping

Crowns were evaluated by a practicing pediatric dentist for trimming and crimping. Trimming was carried out using a diamond burr, removing up to 2 mm of material along the interproximal marginal edge. The trimmed region was subsequently crimped using crimping pliers (No. 800-421, 3M Company) to a typical extent. Visual observation of any coating damage, e.g., cracking, chipping, flaking, delamination, was made and reported following the crimping and trimming of each coated crown.

### Examples

### Preparatory Example: PolyTHF Dimethacrylate

To a jar containing ˜78 g of polyTHF diol being stirred at 50° C. was added ˜0.2 mL of dibutyl tin dilaurate. After stirring for 5 minutes, ˜11 mL of IEM was added dropwise over 5 minutes. The resulting mixture was stirred for 24 h at ˜50° C., then cooled to room temperature. Conversion of the isocyanate was confirmed by IR spectroscopy.

### Preparatory Example: TiO2, Surface Treated

To a mixture of approximately 4.4 parts of GF-31 with 4.4 parts of methanol was added a mixture of approximately 1.5 parts deionized water and 1.5 parts glacial acetic acid, adjusted to a pH of ˜2. This solution was added to a preblended mixture of TiO2 (96 parts) and Aerosil R-972 (1.7 parts) and stirred for approximately 10 minutes. The resulting surface treated filler was placed in an oven and dried above 100° C. for ˜4h.

TABLE 2
Coating compositions (parts by weight)

| | | Coating | Coating | Coating | Coating |
|---|---|---|---|---|---|
| Component | Coating 1 | 2 | 3 | 4 | 5 |
| UDMA | 25.8 | 88.2 | 62.7 | 23.2 | 48.5 |
| SR340 | 25.8 | | | 23.2 | 2.5 |
| PolyTHF | 5.7 | | | | |
| dimethacrylate | | | | | |
| PolyTHF di-IEM | | | | 11.6 | 0 |
| Dibenzoyl peroxide | | | | 0.3 | 0.3 |
| Irgacure 819 | 1.2 | 1.8 | 1.3 | 0.2 | 0.3 |
| DCP | 0.3 | | | | |
| BYK 2155 | 0.4 | | | 0.4 | 1.4 |
| CC59 | 0.2 | | | 0.2 | 0 |
| TiO2, surface treated | 40.0 | 5.0 | | 40 | 5.0 |
| TS-720 | 0.5 | 5.0 | | 1.0 | 2.0 |
| Silica/zirconia cluster | | | 30.0 | | 40 |
| Aerosil R8125 | | | 6.0 | | |

These components were preheated at 80° C. in an oven and were mixed in a Speedmixer until uniformly dispersed. First, the resin components were mixed, then the remaining pigments and/or fillers and surfactants were added and Speedmixed to a uniform dispersion.

### Example 1

A stainless steel primary molar crown (3M-ESPE) was sandblasted with Rocatec Plus sandblasting media (3M-ESPE) and surface-treated with GF-31 in 50/50 ethanol/water acidified with glacial acetic acid to a pH of ˜4 for 3 min. at room temperature, then rinsed in absolute ethanol. The treated crowns were then baked in a 120 deg. C. oven for 20 min. The resulting treated crown was sprayed with a Sono-Tek Ultrasonic Spray Head (Sono-Tek Corp, Milton, N.Y.) with a 60 wt % solution of Coating 1 in isopropanol, to obtain a thickness of ˜0.05 mm. This coating was cured for 10 s with a QTH dental curing light (XL2500, 3M-ESPE). The resulting coated crown was subsequently sprayed with a 50 wt % solution of Coating 2 in isopropanol on the occlusal surface above the height of contour. The coating was cured by exposure to an array of 455 nm LEDs under a CO2 atmosphere, and postcured in an oven for 1 h at 140° C. under nitrogen. The result was a thin smooth white coating with no steel visible with the anatomical details of the original crown intact.

### Example 2

A stainless steel primary molar crown (3M-ESPE) was sandblasted with Rocatec Plus sandblasting media (3M-ESPE) and surface-treated with GF-31 in 50/50 ethanol/water acidified with glacial acetic acid to a pH of ˜4 for 3 min. at room temperature, then rinsed in absolute ethanol. The treated crowns were then baked in a 120 deg. C. oven for 20 min. The resulting treated crown was sprayed with a Sono-Tek Ultrasonic Spray Head (Sono-Tek Corp, Milton, N.Y.) with a 60 wt % solution of Coating 1 in isopropanol, to obtain a thickness of ˜0.05 mm. This coating was cured for 10 s with a QTH dental curing light (XL2500, 3M-ESPE). The resulting coated crown was subsequently sprayed with a 50 wt % solution of Coating 3 in isopropanol on the occlusal surface above the height of contour. The coating was cured by exposure to an array of 455 nm LEDs under a CO2 atmosphere, and postcured in an oven for 1 h at 140° C. under nitrogen. The result was a thin smooth white coating with no steel visible with the anatomical details of the original crown intact.

### Example 3 & 4

Coating compositions 4 and 5 were applied to sheets of 150 μm thick stainless steel by spraying a 50 wt % solution of the coating in acetone with a Sono-Tek ultrasonic sprayhead to achieve thicknesses of approximately 25, 50 and 75 μm. The stainless steel had previously been prepared by sandblasting with Rocatec Plus sandblasting media (3M-ESPE), silane-treated with GF-31 (2 wt % in a 1:1 solution of ethanol and water, pH adjusted to about 4 using glacial acetic acid), and baked at 80 deg. C. for 20 minutes. The sprayed coatings were cured by exposure to an array of 455 nm LEDs in a nitrogen atmosphere, followed by thermal curing at 110° C. in a nitrogen atmosphere for 2 h.

### Examples 5 & 6

Samples of coatings 4 and 5 were applied to brass wear wheel segments by spraying a 50 wt % solution of the coating in acetone with a Sono-Tek ultrasonic sprayhead, with a resulting coating thickness of between 250 and 300 μm. The resulting samples were cured by light and thermal exposure under nitrogen atmosphere as described previously.

### Comparative Example 1

A coated stainless steel crown was prepared as described in U.S. Pat. No. 7,008,229 (Stoller et al.), using a coating similar to Powder II (Column 9).

### Comparative Example 2

A commercially available veneered stainless steel molar crown (NuSmile, Orthodontic Technologies, Inc., Houston, Tex.).

### Comparative Example 3

Preparation of the Z250 comparative composite was pressed out into an approximately 250 um thick sheet and transferred to a wear wheel segment that had been prepared by sandblasting, silane treating, and treating with Adper Singlebond Plus (3M ESPE) per manufacturer's instructions.

### Test Results

### Trimming and Crimping

A coated crown of Example 1 was trimmed and crimped. Little to no evidence of edge fracture was observable to the naked eye after this evaluation.

A crown of Comparative Example 1 was evaluated. Evidence of chipping and delamination was clearly visible to the naked eye along the crimped, trimmed edge of the crown.

A crown of Comparative Example 2 was evaluated. Crimping was attempted along the coated surface using festooning pliers (3M-ESPE). Due to the thickness and modulus of the esthetic coating, the marginal edge of the crown could not be crimped using reasonable force by the dentist.

TABLE 3
Crimping and Trimming Observations of Coated Crowns

| Coated | | |
|---|---|---|
| Crown Example | Crimping Observations | Trimming Observations |
| 1 | OK | OK |
| 2 | Not tested | Not tested |
| CE-1 | Chipping | Delamination |
| CE-2 | Not possible | Not tested |

### Two Body Wear

A coated crown of Example 1 was prepared and wear tested. The crown's appearance was evaluated every 5000 cycles to 25000 cycles. At the end of 25000 cycles, no steel was exposed in the wear facet.

A coated crown of Example 2 was prepared and wear tested. The crown's appearance was evaluated every 5000 cycles to 25000 cycles. At the end of 25000 cycles, no steel was exposed in the wear facet.

A coated crown of Comparative Example 1 was prepared and wear tested. After 5000 cycles, the underlying steel was exposed in the wear facet. The exposed steel area continued to grow through the wear cycle to 25000 cycles.

TABLE 4
Two-Body Wear Results of Polymer Coated Metal Crowns

| Coated | | | | | | |
|---|---|---|---|---|---|---|
| Crown | | 5000 | 10,000 | 15,000 | 20,000 | 25,000 |
| Tested | Initial | cycles | cycles | cycles | cycles | cycles |
| 1 | 5 | 4 | 4 | 4 | 4 | 4 |
| 2 | 5 | 4 | 4 | 4 | 4 | 4 |
| CE-1 | 5 | 3 | 3 | 2 | 2 | 2 |

### Flexibility

Three replicates of Example 3 were prepared and tested for flexibility. Each sample successfully bent around the 2 mm mandrel 180° without cracking

Three replicates of Example 4 were prepared and tested for flexibility. Each sample thickness cracked prior to reaching 180° around the 2 mm mandrel.

TABLE 5
Bend Testing Results

Coating Thickness

| Example # | 25 μm | 50 μm | 75 μm |
|---|---|---|---|
| 3 | 180° - pass | 180° - pass | 180° - pass |
| 4 | 95° - fail | 50° - fail | 45° - fail |

### Three Body Wear

Two coated brass wheel segments of Comparative Example 3 were prepared and wear tested. The slope of the resulting loss of material versus number of cycles was calculated and set as a comparative baseline.

Two coated brass wheel segments of Example 5 were prepared and wear tested. After 200,000 cycles the slope of was calculated as 0.302-9.3 times the slope of Comparative Example 3. The higher slope signifies a greater loss of material per 10,000 cycles.

Two coated brass wheel segments of Example 5 were prepared and wear tested. After 200,000 cycles the slope of was calculated as 0.093-2.9 times the slope of Comparative Example 3.

TABLE 6
Three Body Wear Results of Polymer Coated Segments

| | Measured slope | Ratio to |
|---|---|---|
| Example Material | (μm/1000 cycles) | Z250 |
| Z250 composite, A1 shade | 0.032 | 1 |
| Example 5 | 0.302 | 9.3 |
| Example 6 | 0.093 | 2.9 |

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A method for coating a medical article comprising:
providing a dental crown comprising a metal substrate, wall surfaces and a height of contour;
depositing a coating, said depositing comprising;
depositing a first hardenable composition on at least a portion of the outer surface of the crown, wherein said depositing forms a first polymer layer;
depositing a second hardenable composition on at least a portion of the first polymer layer, wherein depositing the second hardenable composition forms a second polymer layer, and wherein each of the first and second hardenable compositions comprise a polymerizable component, wherein one of the first and second hardenable compositions is deposited substantially above the height of contour.

2. The method of claim 1, further comprising priming at least a portion of a surface of the crown.

3. The method of claim 1, further comprising depositing a third hardenable composition, wherein depositing a third hardenable composition forms a third polymer layer, and wherein the third hardenable composition comprises a polymerizable component.

4. The method of claim 3, wherein at least one of the polymerizable components of the first, second, and third polymerizable components comprises a (meth)acrylate monomer.

5. The method of claim 4, wherein at least one of the first, second, and third polymerizable components is selected from the group consisting of phenoxoyethyl methacrylate, urethane dimethacrylate, polyethylene glycol methacrylate, polypropylene glycol methacrylate, triethyleneglycol dimethacrylate, the diglycidyl methacrylate of bisphenol A, and combinations thereof.

6. (canceled)

7. (canceled)

8. The method of claim 1, wherein at least one of first or second hardenable compositions further comprises a pigment selected from the group consisting of titanium dioxide, iron oxide, and combinations thereof.

9. (canceled)

10. The method of claim 9, wherein the thickness of the coating on wall surfaces below the height of contour is no greater than 100 microns.

11. The method of claim 1, wherein the coating comprises a thickness gradient in at least one of the first and second polymeric layers.

12. A coated dental article comprising:
a dental crown having a height of contour;
a first layer of material disposed on at least a portion of the outer surface of the crown, wherein the first layer comprises a first hardened dental composition; and
a second layer of material disposed on at least a portion of the first layer, wherein the second layer comprises a second hardened dental composition, wherein either the first or second layer is disposed on at least a portion of the outer surface substantially above the height of contour.

13. The dental article of claim 12 further comprising a third layer of material disposed proximate the second layer, wherein the third layer comprises a third hardened dental composition.

14. The dental article of claim 12, wherein the first layer is disposed substantially above the height of contour and comprises a thickness of no greater than 450 microns.

15. The dental article of claim 12, wherein the second layer is disposed substantially above the height of contour and comprises a thickness of no greater than 450 microns.

16. The dental article of claim 12, wherein the thickness of the coating on wall surfaces below the height of contour is no greater than 100 microns.

17. The dental article of claim 13, wherein the first hardened composition comprises a first polymerizable component, a pigment, and a filler;
the second hardened composition comprises a second polymerizable component, a pigment, and a filler; and
the third hardened composition comprising a third polymerizable component.

18. The dental article of claim 17, wherein each polymerizable component of the first, second, and third polymerizable components comprises at least one (meth)acrylate monomer.

19. The article of claim 17, wherein at least one polymerizable component is selected from the group consisting of phenoxoyethyl methacrylate, urethane dimethacrylate, polyethylene glycol methacrylate, polypropylene glycol methacrylate, triethyleneglycol dimethacrylate, the diglycidyl methacrylate of bisphenol A, and combinations thereof

20. The article of claim 17, wherein at least one polymerizable component comprises a core-shell polymer compound.

21. (canceled)

22. (canceled)

23. (canceled)

24. (canceled)

25. (canceled)

26. (canceled)

27. (canceled)

28. The article of claim 17, further comprising a thickness gradient in at least one of the polymeric layers.

29. The article of claim 17, wherein at least one polymerizable component of the first, second, and third polymerizable components comprises a flexible monomer or multi(meth)acrylate oligomer.

30. (canceled)

31. A kit comprising:
a crown;
a first hardenable composition comprising a first polymerizable component, a first pigment, and a first filler;
a second hardenable composition comprising a second polymerizable component, a second pigment, and a second filler;
optionally a third hardenable composition comprising a second polymerizable component, wherein the first, second, and third polymerizable components comprise at least one (meth)acrylate monomer; and
at least one of a cement, a brush, and instructions for application of the hardenable dental compositions.
